(19) United States
(12) Patent Application Publication
(10) Pub. No.: US 2006/0153993 A1
(43) Pub. Date: Jul. 13, 2006

(54) Liquid-repellent coating composition and coating having high alkali resistance

(76) Inventors: Helmut Schmidt, Saarbruecken-Guedingen (DE); Peter Mueller, Lingen (DE); Steffen Pilotek, Saarbrucken (DE); Carsten Becker-Willinger, Saarbruecken (DE); Pamela Kalmes, Merchweiler (DE); Norio Ohkuma, Tokyo (JP); Etsuko Hino, Tokyo (JP); Akihiko Shimomura, Tokyo (JP)

Correspondence Address: HOLLANDER LAW FIRM, P.L.C., SUITE 305, 10300 EATON PLACE, FAIRFAX, VA, 22030, US

(21) Appl. No.: 11/297,199

(22) Filed: Dec. 8, 2005

Related U.S. Application Data
(63) Continuation of application No. PCT/EP03/07999, filed on Jul. 22, 2003.

(51) Int. Cl. B05D 1/36; C08F 2/48; C08J 7/04; C08G 77/24

(52) U.S. Cl. 427/470; 427/508; 427/515; 528/42

(57) ABSTRACT

A coating composition comprising a) a condensation product of at least one hydrolyzable silane having a fluorine-containing group and at least one hydrolyzable silane having a cationically polymerizable group, and b) a cationic initiator, provides, upon curing, substrates with an alkali-resistant, liquid-repellent coating.

### RELATED APPLICATIONS

This application is a continuation application of international application No. PCT/EP2003/007999 filed Jul. 22, 2003, for Liquid-Repellent Coating Composition and Coating Having High Alkali Resistance, in the name of Helmut SCHMIDT, Peter MUELLER, Steffen PILOTEK, Carsten BECKER-WILLINGER, Pamela KALMES, Norio OHKUMA, Etsuko HINO, and Akihiko SHIMOMURA, published as International Patent Publication No. WO 2005/014742 A1, published Feb. 17, 2005, the disclosures of which are herein incorporated by reference in their entireties.

### FIELD OF THE INVENTION

The present invention relates to a coating system based on organic/inorganic polycondensates containing fluorine-containing groups and cationically polymerizable groups, to substrates coated with this coating composition, and to a method of preparing a substrate having such a coating.

### BACKGROUND OF THE INVENTION

The demand for coatings of low surface free energy is still large. Coating compositions of polymers such as polytetrafluoroethylene (PTFE) or acrylates containing perfluorinated polymeric chains have been developed. Whereas the use of PTFE is rather difficult due to the high curing temperatures, fluorinated acrylates have a rather low thermal and mechanical stability. Therefore, hybrid materials have been developed which comprise an inorganic backbone and fluorinated silanes in the side chains. These systems exhibit increased mechanical and thermal stability.

The use of such hybrid materials in pattern forming methods wherein coatings of said materials are patternwise exposed to light in order to achieve a selective radical polymerisation have been described. Generally, such systems are characterized by high inorganic contents in order to obtain satisfactory mechanical properties. However, photosensitive characteristics for patterning by photolithography are limited due to the inorganic backbone of the coating.

One of the major drawbacks of such systems is the high sensitivity to alkaline solutions, since Si—O—Si bonds of the inorganic backbone are susceptible to cleavage at higher pH values. As mentioned above, the pattern forming properties in methods based on photoreactions are significantly reduced by the inorganic backbone. In order to achieve high mechanical stability and suitability for radical polymerisation based photolithography, high curing temperatures are needed, generally above 150° C. to 200° C. However, this does not solve the problem of high sensitivity at higher pH values.

Hence, coatings having liquid-repellent properties still require further improvement in properties, such as mechanical stability, alkali resistance and sensitizing characteristics in pattern forming applications. Another desired property is a high wiping stability and wear stability.

Accordingly, it is an object of the present invention to provide a substrate having a liquid-repellent coating of high alkali resistance. The coating should also be durable with respect to other chemical or mechanical attack such as wiping. It is further intended that the coated substrates can be used in pattern forming methods where high photosensitive characteristics are necessary.

These and other objects are achieved in accordance with the invention by means of a coating composition comprising a) a condensation product of at least one hydrolyzable silane having a fluorine-containing group and at least one hydrolyzable silane having a cationically polymerizable group, and b) a cationic initiator.

### SUMMARY OF THE INVENTION

The present invention provides a coating composition for producing an unexpectedly superior alkali-resistant, liquid-repellent layer on a substrate, such as metal, glass, ceramic, or polymer substrates, which may be optionally pre-treated or pre-coated. The coating composition may include: a) a condensation product of at least one hydrolyzable silane having a fluorine-containing group and at least one hydrolyzable silane having a cationically polymerizable group, and b) a cationic initiator. The coating composition may be applied to a substrate, optionally dried, and then cured or hardened by exposure to light or radiation, or heat, or a combination thereof. In a preferred embodiment, a substrate having a two layer composite coat may be produced. A substrate having top coat which is an alkali-resistant, liquid-repellent coating in accordance with the present invention may be prepared by applying a coating layer composition which includes a cationically photopolymerizable material and a cationic initiator to a substrate, and optionally drying the applied coating layer. Then, a coating composition for an alkali-resistant, liquid-repellent layer may be applied on the resulting coating layer. The coating composition for the top or second layer may include a condensation product of at least one hydrolyzable silane having a fluorine-containing group and at least one hydrolyzable silane having a cationically polymerizable group, and optionally a cationic initiator. Each of the layers may be cured by irradiation and/or heat, with the curing of both layers preferably being simultaneously.

### DETAILED DESCRIPTION OF THE INVENTION

Use of the coating composition according to the present invention results in a coating having outstanding properties. In particular, it was completely unexpected that coatings obtained with this coating composition were found to have an extremely high alkali resistance as evidenced by the fact that in highly alkaline solutions with a pH above 10, the coatings were stable for three months at 60° C. Such chemical resistance is not achieved by the hybrid material coatings according to the state of the art. Moreover, even though the coating compositions of the present invention have a relatively high silicate content, they also provide photosensitive characteristics and may therefore be used in pattern forming methods involving photoreactions. Furthermore, the coatings obtained have very good durability and wiping stability, while maintaining their excellent liquid-repellent properties.

A further surprising discovery was that the coating compositions show improved adhesion properties. This improved adhesion is especially advantageous when the coating composition is used as the top layer on a substrate to be provided with two individual layers, particularly when both layers are cured simultaneously. For example, the coating composition is suitable for use as a liquid-repellent layer, where the coating composition of the present invention is applied to an appropriate layer of a substrate and then both layers are cured simultaneously. In this manner, a very desirable layer composite is obtained showing excellent adhesion.

Without wishing to be bound to any theory, the surprising improvements of the present invention are believed to result at least partially from the combination of the inorganic silicate backbone and the organic polymeric network formed at the same time through the cationically polymerizable groups by means of the cationic initiator. The cationic groups may be polymerized by a cationic polymerisation process, which at the same time may also enhance the condensation degree within the inorganic silicate network.

The low surface free energy of the coatings prepared from the coating compositions caused by the fluorinated silanes results in highly liquid-repellent properties. Apparently, a very specific structure is formed according to the invention, which likely includes an interpenetrating network (IPN) leading to the surprising stability not known from other systems. It is assumed that phase separation leading to silicate rich and silicate poor domains is avoided, and the organic polymeric network formed being stable toward alkaline attack also prevents the dissolution of the silicate by immobilising the inorganic backbone within the organic polymeric network.

The cured coating composition comprises a siloxane framework (inorganic framework) formed from the hydrolyzable silanes and an organic framework formed by the cationically polymerized groups, which is linked by ether bonds if epoxy groups are used. In this manner, the cured coating compositions will be a hybrid material wherein organic and inorganic components are combined.

One important feature of the present invention is the presence of the cationic initiator, i.e. the fact that the formation and curing of the coating compositions involves cationic polymerization reactions. Without wishing to be bound to any theory, the surprising improved resistance to chemicals, especially the alkali resistance, compared to systems involving radical polymerisation reactions is believed to be the result of cationic polymerisation reactions which lead to linkages, typically ether linkages in the case of epoxy groups, apparently resulting in a more stable network so that the coatings obtained will be hardly hydrolysed in highly alkaline solutions.

In the following, the present invention will be described in more detail.

The coating composition of the invention comprises a condensation product of at least one hydrolyzable silane having a fluorine-containing group and at least one hydrolyzable silane having a cationically polymerizable group.

The condensation product is based on at least two different hydrolyzable silanes. Hydrolyzable silanes comprise at least one hydrolyzable substituent. The at least one hydrolyzable silane having a fluorine-containing group is a silane having hydrolyzable substituents and at least one non-hydrolyzable substituent carrying at least one fluorine atom which is generally bound to a carbon atom. For simplification, these silanes are sometimes referred to below as fluorosilanes. Specific examples of fluorosilanes which can be used in accordance with the invention can be taken from WO 92/21729, hereby incorporated by reference in its entirety.

Said fluorosilane preferably comprises only one non-hydrolyzable substituent having a fluorine-containing group, but may also contain a further non-hydrolyzable substituent having no fluorine atoms. The at least one non-hydrolyzable substituent containing a fluorine-containing group of the fluorosilane contains generally at least 1, preferably at least 3 and in particular at least 5 fluorine atoms, and generally not more than 30, more preferably not more than 25 and especially not more than 21 fluorine atoms which are attached to one or more carbon atoms. It is preferred that said carbon atoms are aliphatic including cycloaliphatic atoms. Further, the carbon atoms to which fluorine atoms are attached are preferably separated by at least two atoms from the silicon atom which are preferably carbon and/or oxygen atoms, e.g. a C₁₋₄ alkylene or a C₁₋₄ alkylenoxy, such as an ethylene or ethylenoxy linkage.

Preferred hydrolyzable silanes having a fluorine-containing group are those of general formula (I):
RfSi(R)_{b}X_{(3-b)} (1)
wherein Rf is a non-hydrolyzable substituent having 1 to 30 fluorine atoms bonded to carbon atoms, R is a non-hydrolyzable substituent, X is a hydrolyzable substituent, and b is an integer from 0 to 2, preferably 0 or 1 and in particular 0.

In general formula (I) the hydrolyzable substituents X, which may be identical or different from one another, are, for example, hydrogen or halogen (F, Cl, Br or I), alkoxy (preferably C₁₋₆ alkoxy, such as methoxy, ethoxy, n-propoxy, isopropoxy and n-butoxy, sec-butoxy, isobutoxy, and tert-butoxy), aryloxy (preferably C₆₋₁₀ aryloxy, such as phenoxy), acyloxy (preferably C₁₋₆ acyloxy, such as acetoxy or propionyloxy), alkylcarbonyl (preferably C₂₋₇ alkycarbonyl, such as acetyl), amino, monoalkylamino or dialkylamino having preferably from 1 to 12, in particular from 1 to 6, carbon atoms. Preferred hydrolyzable radicals are halogen, alkoxy groups, and acyloxy groups. Particularly preferred hydrolyzable radicals are C₁₋₄ alkoxy groups, especially methoxy and ethoxy.

The non-hydrolyzable substituent R, which may be identical to or different from one another, may be a non-hydrolyzable radical R containing a functional group or may be a non-hydrolyzable radicals R without a functional group. In general formula (I) the substituent R, if present, is preferably a radical without a functional group.

The non-hydrolyzable radical R without a functional group is, for example, alkyl (e.g., C₁₋₈ alkyl, preferably C₁₋₆ alkyl, such as methyl, ethyl, n-propyl, isopropyl, n-butyl, s-butyl and t-butyl, pentyl, hexyl, and octyl), cycloalkyl (e.g. C₃₋₈ cycloalkyl, such as cyclopropyl, cyclopentyl or cyclohexyl), alkenyl (e.g. C₂₋₆ alkenyl, such as vinyl, 1-propenyl, 2-propenyl and butenyl), alkynyl (e.g. C₂₋₆ alkynyl, such as acetylenyl and propargyl), cycloalkenyl and cycloalkynyl (e.g. C₂₋₆ alkenyl and cycloalkynyl), aryl (e.g. C₆₋₁₀ aryl, such as phenyl and naphthyl), and corresponding arylalkyl and alkylaryl (e.g. C₇₋₁₅ arylalkyl and alkylaryl, such as benzyl or tolyl). The radicals R may contain one or more substituents, such as halogen, alkyl, aryl, and alkoxy. In formula (I) R when present is preferably methyl or ethyl.

As mentioned above, the non-hydrolyzable substituent R of formula (I) may contain also one or more functional groups. Examples of such groups can be found in the definition of substituent R having functional groups in formula (III) below. Principally, also the substituent Rc defined below in formula (II) may be considered as a non-hydrolyzable substituent R having a functional group.

The non-hydrolyzable substituent Rf comprises at least 1, preferably at least 3 and in particular at least 5 fluorine atoms, and generally not more than 30, more preferably not more than 25 and especially not more than 21 fluorine atoms which are attached to one or more carbon atoms. It is preferred that said carbon atoms are aliphatic including cycloaliphatic atoms. Further the carbon atoms to which fluorine atoms are attached are preferably separated by at least two atoms from the silicon which are preferably carbon and/or oxygen atoms, e.g. a C₁₋₄ alkylene or a C₁₋₄ alkylenoxy, such as an ethylene or ethylenoxy linkage.

The substituent Rf has preferably less than 20 carbon atoms and it is preferred that it has at least 3 carbon atoms where a preferred range includes from 3 to 15 carbon atoms. The carbon atoms to which the fluorine atoms are attached are preferably aliphatic carbon atoms which includes cycloaliphatic carbon atoms. Rf comprises preferably a fluorinated or perfluorinated alkyl group linked via an alkylene or alkylenoxy unit to the silicon atom. A particular preferred substituent Rf is CF₃(CF₂)ₙ-Z where n and Z are defined as defined in formula (IV) below. Specific examples of Rf are CF₃CH₂CH₂, C₂F₅CH₂CH₂, C₄H₉C₂H₄, n-C₆F₁₃CH₂CH₂, i-C₃F₇OCH₂CH₂CH₂, n-C₈F₁₇CH₂CH₂, i-C₃F₇O(CH₂)₃ and n-C₁₀F₂₁CH₂CH₂. Partic n-C₆F₁₃CH₂CH₂, n-C₈F₁₇CH₂CH₂, and n-C₁₀F₂₁CH₂CH₂.

A particular preferred silane is a compound of general formula (IV)
CF₃(CF₂)ₙ-Z-SiX₃ (IV)
wherein X is as defined in general formula (I) and preferably is methoxy or ethoxy, Z is a divalent organic group, and n is an integer from 0 to 20, preferably 3 to 15, more preferably 5 to 10. Preferably, Z contains not more than 10 carbon atoms and Z is more preferably a divalent alkylene or alkyleneoxy group having not more than 6, in particular not more than 4 carbon atoms, such as methylene, ethylene, propylene, butylene, methylenoxy, ethyleneoxy, propylenoxy, and butylenoxy. Most preferred is ethylene.

Specific examples are CF₃CH₂CH₂SiCl₂(CH₃), CF₃CH₂CH₂SiCl(CH₃)₂, CF₃CH₂CH₂Si(CH₃)(OCH₃)₂, CF₃CH₂CH₂SiX₃, C₂F₅CH₂CH₂SiX₃, C₄F₉CH₂CH₂SiX₃, n-C₆F₁₃CH₂CH₂SiX₃, n-C₈F₁₇CH₂CH₂SiX₃, n-C₁₀F₂₁CH₂CH₂SiX₃ (X═OCH₃, OC₂H₅ or Cl); i-C₃F₇O—CH₂CH₂CH₂—SiCl₂(CH₃), n-C₆F₁₃—CH₂CH₂—SiCl(OCH₂CH₃)₂, n-C₆F₁₃—CH₂CH₂—SiCl₂(CH₃) and n-C₆F₁₃—CH₂CH₂—SiCl(CH₃)₂. Particularly preferred are CF₃—C₂H₄—SiX₃, C₂F₅—C₂H₄—SiX₃, C₄F₉—C₂H₄—SiX₃, C₆F₁₃—C₂H₄—SiX₃, C₈F₁₇—C₂H₄—SiX₃, and C₁₀F₂₁—C₂H₄—SiX₃, where X is a methoxy or ethoxy group.

Furthermore, the inventors have found that by using at least two different hydrolyzable silanes having a fluorine-containing group of a different kind unexpectedly improved results are obtained, especially with regard to liquid-repellent properties, wiping-proof properties, and resistance to chemicals such as developing solutions or alkaline solutions. The silanes used preferably differ in the number of fluorine atoms contained therein or in the length (number of carbon atoms in the chain) of the fluorine-containing substituent.

Although the reason for these improvements is not clear, the fluoroalkyl groups of different length are believed to cause a structural arrangement of higher density, since the fluoroalkyl group should take an optimal arrangement in the uppermost surface. For example, in the case where at least two of C₆F₁₃—C₂H₄—SiX₃, C₈F₁₇—C₂H₄—SiX₃, and C₁₀F₂₁—C₂H₄—SiX₃ (X as defined above) are used together, the high fluoride concentration in the uppermost surface is represented by fluoroalkyl groups of different length which results in the named improvements compared to the addition of a single fluorosilane.

The hydrolyzable silane having a cationically polymerizable group comprises at least one hydrolyzable substituent and at least one non-hydrolyzable substituent containing at least one cationically polymerizable group. Cationically polymerizable groups which can be polymerised or crosslinked by a cationic initiator are known to the person skilled in the art.

Specific examples of cationically polymerizable group are cyclic ether groups (preferably epoxy groups including glycidyl and glycidoxy), cyclic thioether groups, spiroorthoester groups, cyclic amide groups (lactam), cyclic ester groups (lactone), cyclic imine, 1,3-dioxacycloalkane (ketale), and vinyl groups to which an electron donating group, e.g. alkyl, alkenyl, alkoxy, aryl, CN, or COOAlkyl, is attached, e.g. a vinyl ether group, an isobutenyl group, or a vinyl phenyl group. Preferred cationically polymerizable groups are epoxy and vinyl ether groups, the epoxy group being particularly preferred, especially in view of its availability and ease of reaction control.

A preferred hydrolyzable silane having a cationically polymerizable group is a compound of general formula (II):
RcSi(R)_{b}X_{(3-b)} (II)
wherein Rc is a non-hydrolyzable substituent having a cationically polymerizable group, R is a non-hydrolyzable substituent, X is a hydrolyzable substituent, and b is an integer from 0 to 2, preferably 0. The substituents X and R are as defined in general formula (I) and formula (III) below.

Specific examples of the cationically polymerizable group of the non-hydrolyzable substituent Rc by way of which polymerizing or crosslinking is possible are epoxide groups, including glycidyl and glycidoxy groups, cyclic thioether groups, spiroorthoester groups and vinyl ether groups. These functional groups are attached to the silicon atom by way of a divalent organic group, such as alkylene, including cycloalkylene, alkenylene or arylene bridge groups, which may be interrupted by oxygen or —NH— groups. Further examples for said bridge groups are the divalent equivalents of all the groups, which have been defined for the non-hydrolyzable radical R without a functional group of general formula (I), which may be interrupted by oxygen or —NH— groups. Of course, the bridge may also contain one or more conventional substituents such as halogen or alkoxy. The bridge is preferably a C₁₋₂₀ alkylene, more preferably a C₁₋₆ alkylene, which may be substituted, for example, methylene, ethylene, propylene or butylene, especially propylene, or cyclohexylalkyl, especially cyclohexylethyl.

Specific examples of said substituent Rc are glycidyl or glycidyloxy C₁₋₂₀ alkyl, such as γ-glycidylpropyl, β-glycidoxyethyl, γ-glycidoxypropyl, δ-glycidoxybutyl, ε-glycidoxypentyl, ω-glycidoxyhexyl, and 2-(3,4-epoxycyclohexyl)ethyl. The most preferred substituents Rc are glycidoxypropyl and epoxycyclohexylethyl.

Specific examples of corresponding silanes are γ-glycidoxypropyltrimethoxysilane (GPTS), γ-glycidoxypropyltriethoxysilane (GPTES), epoxycyclohexylethyltrimethoxysilane, and epoxycyclohexylethyltriethoxysilane. However, the invention is not limited to the above-mentioned compounds.

According to one embodiment of the present invention, a further silane may be used for preparing the condensation product, which silane may be selected from one or more silanes having at least one alkyl substituent, a silane having at least one aryl substituent, and a silane having no non-hydrolyzable substituent. The hydrolyzable or non-hydrolyzable substituents of the silanes may be unsubstituted or substituted. Examples of suitable substituents are conventional substituents such as halogen or alkoxy or the functional groups defined for formula (III) below. Said silanes having alkyl substituents, aryl substituents or having no non-hydrolyzable substituent can be used for controlling the physical properties of the liquid-repellent layer.

Preferred further hydrolyzable silanes which may be used in the present invention are those of general formula (III):
RₐSiX₍₄₋ₐ₎ (III)
wherein R is a non-hydrolyzable substituent preferably independently selected from substituted or unsubstituted alkyl and substituted or unsubstituted aryl, X is a hydrolyzable substituent, and a is an integer from 0 to 3. In the case where a is 0, the silane contains only hydrolyzable groups. The substituents R and X have the same meanings as defined in formula (I).

As in formula (I), the non-hydrolyzable substituent R may contain a functional group, though R is preferably a radical without such functional group. A functional group means here a relatively reactive group, which may undergo a reaction in the course of the preparation of the coatings, though it may also remain unreacted. The cationically polymerizable groups of the silanes of formula (II) are excluded.

Specific examples of functional groups are isocyanato, hydroxyl, ether, amino, monoalkylamino, dialkylamino, optionally substituted anilino, amide, carboxyl, allyl, acryloyl, acryloyloxy, methacryloyl, methacryloyloxy, mercapto, and cyano. These functional groups are attached to the silicon atom by way of a divalent organic group, such as alkylene, including cycloalkylene, alkenylene or arylene bridge groups, which may be interrupted by oxygen or —NH— groups. Examples for said bridge groups are the divalent equivalents of all the groups, which have been defined for the non-hydrolyzable radical R without a functional group of general formula (I), which may be interrupted by oxygen or —NH— groups. Of course, the bridge may also contain one or more conventional substituents such as halogen or alkoxy.

As mentioned above, the substituent R of the further silane represented by formula (III) is preferably a substituent without a functional group. In formula (III), R is preferably alkyl, preferably C₁₋₆ alkyl, or aryl, preferably phenyl, and X is preferably C₁₋₄ alkoxy, preferably methoxy or ethoxy.

Specific, non-limiting examples of said further hydrolyzable silanes are tetramethoxysilane, tetraethoxysilane, tetrapropoxysilane, methyltrimethoxysilane, methyltriethoxysilane, methyltripropoxysilane, ethyltrimethoxysilane, ethyltriethoxysilane, ethyltripropoxysilane, propyltrimethoxysilane, propyltriethoxysilane, propyltripropoxy-silane, phenyltrimethoxysilane, phenyltriethoxysilane, phenyltripropoxysilane, dimethyldiethoxysilane, dimethyldimethoxysilane, diphenyldimethoxysilane, and diphenyldiethoxysilane.

The proportion of the silanes used for preparing the condensation product is selected according to the application desired and is within the knowledge of a person skilled in the art of manufacture of inorganic polycondensates. It has been found that the hydrolyzable silanes having a fluorine-containing group are appropriately used in amounts in the range from 0.5 to 20% by mole, preferably 1 to 10% by mole, based on the total amount of hydrolyzable compounds used. Within these ranges a high liquid repellency as well as a very uniform surface are obtained. The latter is especially important for photocuring and/or recording applications involving irradiation since the surface obtained often tends to have concave and/or convex forms which affect light scattering. Thus, the above-mentioned ranges provide highly repellent, even surfaces which are especially suited for photocuring and/or recording applications.

The proportion between the hydrolyzable silane having the cationically polymerizable group and the further hydrolyzable silane is preferably in the range of 10:1-1:10.

For the preparation of the condensation product, also other hydrolyzable metal compounds not containing silicon may be used in minor amounts. These hydrolyzable compounds may be selected from at least one metal M from main groups III to V, especially III and IV and/or transition groups II to V of the periodic table of the elements, and preferably comprise hydrolyzable compounds of Al, B, Sn, Ti, Zr, V or Zn, especially those of Al, Ti or Zr, or mixtures of two or more of these elements. These compounds normally satisfy the formula MXₙ where X is as defined in formula (I), typically alkoxy, and n equals the valence of the metal M (usually 3 or 4). One or more substituents X may be substituted by a chelate ligand. Also, hydrolyzable compounds of metals of main groups I and II of the periodic table (e.g., Na, K, Ca and Mg), from transition groups VI to VII of the periodic table (e.g., Mn, Cr, Fe, and Ni), and of the lanthanides may be used. As noted above, these other hydrolyzable compounds are generally used in low amounts, e.g. in catalytic amounts, if at all. The optional catalytic use is explained below.

Generally, the condensation product of the above-mentioned hydrolyzable silanes is prepared by hydrolysis and condensation of said starting compounds in accordance with the sol-gel method, which is known to those skilled in the art. The sol-gel method generally comprises the hydrolysis of said hydrolyzable silanes, optionally aided by acid or basic catalysis. The hydrolysed species will condense at least partially. The hydrolysis and condensation reactions cause the formation of condensation products having e.g. hydroxy groups and/or oxo bridges. The hydrolysis/condensation product may be controlled by appropriately adjusting parameters, such as e.g. the water content for hydrolysis, temperature, period of time, pH value, solvent type, and solvent amount, in order to obtain the condensation degree and viscosity desired.

Moreover, it is also possible to use a metal alkoxide in order to catalyse the hydrolysis and to control the degree of condensation. For said metal alkoxide, the other hydrolyzable compounds defined above may be used, especially an aluminum alkoxide, a titanium alkoxide, a zirconium alkoxide, and corresponding complex compounds (e.g. with acetyl acetone as the complex ligand) are appropriate.

In the sol-gel process, a solvent may be used. However, it is also possible to conduct the sol-gel process without a solvent. Usual solvents may be used, e.g. alcohols such as aliphatic C₁-C₈ alcohols, e.g. methanol, ethanol, 1-propanol, isopropanol and n-butanol, ketones, such as C₁₋₆ alkylketones, e.g. acetone and methyl isobutyl ketone, ether, such as C₁₋₆ dialkylether, e.g. diethylether, or diolmonoether, amides, e.g. dimethylformamide, tetrahydrofuran, dioxane, sulfoxides, sulfones, and glycol, e.g. butylglycol, and mixtures thereof. Alcohols are preferred solvents. The alcohol obtained during the hydrolysis of hydrolyzable silane alkoxides may serve as a solvent.

Further details of the sol-gel process may e.g. be found in C. J. Brinker, G. W. Scherer: “Sol-Gel Science—The Physics and Chemistry of Sol-Gel-Processing”, Academic Press, Boston, San Diego, New York, Sydney (1990). Instead of the hydrolyzable silane monomers already partially or completely (pre)hydrolysed species or precondensates of said monomers may be used as starting materials. The condensation product used in the present invention represents an organically modified inorganic polycondensate due to the non-hydrolyzable organic substituents of the silanes used. The condensation degree and viscosity depend from the properties desired and can the controlled by the skilled person. Usually a rather complete condensation degree in respect to silicon will be obtained in the final cured product. The cationically polymerizable groups contained in the condensation product of the coating composition are normally yet essentially unreacted and serve for polymerising or crosslinking during the following curing step.

The coating composition according to the present invention further contains a cationic initiator. Cationic initiators are commercially available and known in the art. The specific type of the cationic initiator used may e.g. depend on the type of cationically polymerizable group present, the mode of initiation (thermal or photolytic), the temperature, the type of radiation (in the case of photolytic initiation) etc.

Suitable initiators include all common initiator/initiating systems, including cationic photoinitiators, cationic thermal initiators, and combinations thereof. Cationic photoinitiators are preferred. Representative of cationic initiators that can be used include onium salts, such as sulfonium, iodonium, carbonium, oxonium, silicenium, dioxolenium, aryldiazonium, selenonium, ferrocenium and immonium salts, borate salts, e.g. [BF₃OH]H (obtainable from BF₃ and traces of water) and corresponding salts of Lewis acids such as AlCl₃, TiCl₄, SnCl₄, compounds containing an imide structure or a triazene structure, Meerwein complexes, e.g. [(C₂H₅)₃O]BF₄, perchloric acid, azo compounds and peroxides. Suitable cationic thermal initiators are 1-methylimidazole, (C₆H₅)₃C⁺[SbCl₆]⁻, (C₆H₅)₃C⁺[SbF₆]⁻, (C₆H₅)₃C⁺[ClO₄]⁻, (C₇H₇)⁺[SbCl₆]⁻, (C₇H₇)⁺[ClO₄]⁻, (C₂H₅)₄N⁺[SbCl₆]⁻, (C₂H₅)₃O⁺[BF₄]⁻ and (C₂H₅)₃S⁺[BF₄]⁻. As cationic photoinitiators aromatic sulfonium salts or aromatic iodonium salts are advantageous in view of sensitivity and stability. Cationic photoinitiators are commercially available, examples being the photoinitiator Degacure® KI 85 (bis[4-(diphenylsulfonio)phenyl]sulfide-bis-hexafluorphosphate), Cyracure® UVI-6974/UVI-6990, Rhodorsil® 2074 (tolylcumyliodonium-tetrakis(pentafluorophenylborate)), Silicolease UV200 Cata® (diphenyliodonium-tetrakis(pentafluorophenylborate)) and SP170® (4,4′-bis[di(β-hydroxyethoxy)phenylsulfonio]phenylsulfide-bis-hexafluoroantimonate).

The cationic initiators are employed in the usual amounts, preferably from 0.01-10% by weight, especially 0.1-5% by weight, based on the total solids content of the coating composition.

The coating composition may comprise further conventional additives in accordance with the purpose and desired properties. Specific examples are thixotropic agents, crosslinking agents, solvents, e.g., the above mentioned solvents, organic and inorganic pigments, UV absorbers, lubricants, levelling agents, wetting agents, adhesion promoters, and surfactants. A crosslinking agent may be an organic compound containing at least two functional groups through which a crosslinking is possible.

For preparing a substrate having a highly alkali-resistant coating, the coating composition according to the present invention may be applied to any desired substrate. Examples thereof are metal, glass, ceramic, and plastic substrates, but also paper, building materials, such as (natural) stones, and concrete, and textiles. Examples of metal substrates include copper, aluminium, iron, including steel, and zinc as well as metal alloys, such as brass. Examples of plastic substrates are polycarbonate, polyamide, polymethyl methacrylate, polyacrylates, and polyethylene terephthalate. Glass or ceramic substrates may be e.g. mainly based on SiO₂, TiO₂, ZrO₂, PbO, B₂O₃, Al₂O₃, and/or P₂O₅. The substrate may be present in any form, such as, e.g., a plate, a sheet or a film. Of course, surface-treated substrates are also suitable, e.g., substrates having sand-blasted, coated or metallized surfaces, e.g. galvanized iron plates. In a particular embodiment, the substrate is coated with at least one base layer.

The coating composition may be applied to the substrate by any conventional means. In this context, all common wet-chemical coating methods may be used. Representatives methods are e.g. direct coating, spin coating, dip coating, spray coating, web coating, bar coating, brush coating, flow coating, doctor blade coating and roll coating and printing methods, such as pat printing, silk screen printing, flexo printing and pad printing. A further suitable method is direct coating.

Following application, the coating may be dried, if necessary. Then, the coating composition applied to the substrate is cured (hardened). The curing step includes a cationic polymerisation of said cationically polymerizable groups. The curing step may be conducted by exposure to light or radiation and/or by heating. In the curing step, the condensation degree of the inorganic polycondensate may be enhanced. Further, the cationically polymerizable groups in the organic side chains will generally polymerise to crosslink the system, thereby forming the desired inorganic-organic hybrid material.

The coating composition according to the present invention is preferably cured by a combination of exposure to light and heating. Exposure and heating can be conducted simultaneously and/or successively. Often it is preferred to cure first by a combined treatment of irradiation and heating and subsequently complete the curing step by further heating alone.

The appropriate irradiation depends e.g. on the type of cationically polymerizable group and the cationic initiator used. For example, UV radiation or laser light may be employed. During the step of exposing to light or radiation and/or heating, the cationic initiator may generate an acid. Besides the polymerisation of the cationically polymerizable groups (crosslinking), this acid may also assist in curing the siloxane framework (inorganic condensation) almost to completion, especially when the coating is heated.

After curing, a low surface free energy coating with extremely high alkali resistance, improved wiping stability and excellent mechanical properties is obtained which also shows surprisingly improved photosensitive characteristics.

In a preferred embodiment of the present invention, a coating obtained by the coating composition of the present invention is used as a top coat in a specific two layer composite coat comprising a cationically photopolymerized coat as a further coating layer.

Accordingly, the present invention also relates to a process of preparing a substrate having an alkali-resistant, liquid-repellent coating, comprising the steps of
a) applying a coating layer composition comprising a cationically photopolymerizable material and a cationic initiator to a substrate,
b) optionally drying said applied coating layer,
c) applying a coating composition for an alkali-resistant, liquid-repellent layer on said coating layer, the composition comprising a condensation product of at least one hydrolyzable silane having a fluorine-containing group and at least one hydrolyzable silane having a cationically polymerizable group, and
d) curing both layers by irradiation.

As for the substrate, the same substrates as mentioned above can be used. Both coating compositions may be applied by any conventional means, examples of which have also been described above. Direct coating is a suitable method, especially for the formation of the liquid-repellent layer. Both layers are cured by irradiation, i.e. by exposure to light or radiation, such as described above. In a preferred embodiment, both layers are cured simultaneously.

The coating layer composition of step a) comprises a cationically photopolymerizable material and a cationic initiator. Suitable initiators include all common initiator/initiating systems that are known in the art, especially cationic photoinitiators. The initiators which may be used are the same as those mentioned above.

The cationically photopolymerizable material of the coating layer composition of step a) is preferably a cationically photopolymerizable epoxy compound known to those skilled in the art. The cationically polymerizable resin can also be any other resin having electron rich nucleophilic groups such as vinylamine, vinylether, vinylaryl or having heteronuclear groups such as aldehydes, ketones, thioketones, diazoalkanes. Of special interest are also resins having cationically polymerizable ring groups such as cyclic ethers, cyclic thioethers, cyclic imines, cyclic esters (lactone), cyclic amide (lactame) or 1,3-dioxacycloalkane (ketale). Further species of cationically polymerizable resins are spiroorthoesters and spiroorthocarbonates such as 1,5,7,11-tetraoxaspiro-[5.5]-undecane. In general, the cationically photopolymerizable material may be a resin material. The epoxy compounds used for the coating layer composition are preferably an epoxy resin.

The coating composition employed in step c) corresponds to the liquid-repellent coating composition described above so that reference can be made to the above description of its components and methods of manufacture. Although, usually also a cationic initiator is added, the inventors have found that since the coating layer composition of step (a) includes a cationic initiator as an essential component, additional incorporation of a cationic initiator into the liquid-repellent coating composition of step c) is not absolutely necessary. Without wishing to be bound to any theory, this surprising result is believed to result from the fact that the cationic initiator or a reaction product thereof resulting from an activation of the initiator in the applied coating layer composition, e.g. an acid generated upon activation of the initiator, is capable of polymerising/crosslinking also the cationically polymerizable groups of the overlaid coating composition, possibly by virtue of diffusion of the cationic initiator or reaction products thereof into the top layer. Hence, also the top layer comprising the condensation product will undergo cationic polymerisation/-crosslinking.

The coating of the invention is especially useful, if the coating is to be contacted with alkaline solutions, but it is also effective in combination with neutral and/or acid solutions.

The coating compositions of the present invention are especially suitable for coating surfaces of metals, plastics, modified or unmodified natural substances, ceramic, concrete, clay and/or glass. The surfaces of metal also include surfaces of metal compounds. Examples which may be mentioned are the metals copper, silver, gold, platinum, palladium, iron, nickel, chromium, zinc, tin, lead, aluminium and titanium, and alloys containing these metals, for example (stainless) steel, brass and bronze.

The above coating composition can also be applied to surfaces of oxides, carbides, silicides, nitrides, borides, etc. of metals and non-metals, for example surfaces which comprise or consist of metal oxides, carbides such as silicon carbide, tungsten carbide and boron carbide, silicon nitride, silicon dioxide, etc.

Among the surfaces of (modified or unmodified) natural substances mention may be made in particular of those of natural stone (sandstone, marble, granite, etc.), (fired) clay and cellulose materials, while it is of course also possible to coat surfaces of concrete, ceramic, porcelain, gypsum, glass and paper (including synthetic paper) in an advantageous manner using the above coating compositions. The term “glass” here includes all types of glass with a very wide variety of compositions, examples being soda lime glass, potash glass, borosilicate glass, lead glass, barium glass, phosphate glass, optical glass, and historical glass.

Among the plastics which form surfaces which can be coated with the above coating compositions are thermoplastics, thermosets, elastomers and foamed plastics. Specific examples of such plastics include homo- and copolymers of olefinically unsaturated compounds, for example olefins such as ethylene, propylene, butenes, pentenes, hexenes, octenes and decenes; dienes such as butadiene, chloroprene, isoprene, hexadiene, ethylidene norbornene and dicyclopentadiene; aromatic vinyl compounds, for example styrene and its derivatives (e.g. methylstyrenes, chlorostyrenes, bromostyrenes, methylstyrenes, etc.); halogenated vinyl compounds, for example vinyl chloride, vinyl fluoride, vinylidene chloride, vinylidene fluoride and tetrafluoroethylene; a,β-unsaturated carbonyl compounds, for example acrylic acid, methacrylic acid, crotonic acid, maleic acid and fumaric acid and their derivatives (especially (alkyl) esters, amides, anhydrides, imides, nitriles and salts, for example ethyl acrylate, methyl methacrylate, acrylonitrile, methacrylonitrile, (meth)acrylamide and maleic anhydride); and vinyl acetate.

Further examples are polyesters such as, for example, polyethylene terephthalate and polybutylene terephthalate; polyamides such as nylons; polyimides; polyurethanes; polyethers; polysulphones; polyacetals; epoxy resins; polycarbonates; polyphenylene sulphides; (vulcanized or non-vulcanized) synthetic rubbers; (vulcanized) natural rubber; phenol-formaldehyde resins; phenol-urea resins; phenol-melamine resins; alkyd resins; and polysiloxanes.

Plastics of this kind may of course contain the customary plastics additives, for example, fillers, pigments, dyes, reinforcing agents (e.g. (glass) fibres), stabilizers, flame proofing agents, inhibitors, and lubricants.

The above coating compositions are particularly suitable for the coating of constructions and parts thereof; means of locomotion and of transport and parts thereof; operating equipment, devices and machines for commercial and industrial purposes and research, and parts thereof; domestic articles and household equipment and parts thereof; equipment, apparatus and accessories for games, sport and leisure, and parts thereof; and also instruments, accessories and devices for medical purposes and sick persons. Specific examples of such coatable materials and articles are indicated below.

Constructions (especially buildings) and parts thereof include:

Interior and exterior facings of buildings, floors and staircases made of natural stone, concrete, etc., floor coverings of plastic, fitted and loose carpets, base boards (skirting boards), windows (especially window frames, window sills, glazing of glass or plastic and window handles), venetian blinds, roller blinds, doors, door handles, WC, bath and kitchen fittings, shower cabinets, sanitary modules, lavatories, pipes (and especially drainage pipes where the deposition of dirt is to be avoided), radiators, mirrors, light switches, wall and floor tiles, lighting, letter boxes, roof tiles, guttering, aerials, satellite dishes, handrails of balconies and moving stairways, architectural glazing, solar collectors, winter gardens, walls of lifts; memorials, sculptures and, generally, works of art made of natural stone (e.g. granite, marble), metal, etc., especially those erected outdoors.

Means of locomotion and of transport (e.g. car, lorry, bus, motorbike, moped, bicycle, railway, tram, ship and aircraft) and parts thereof:

Headlamps, interior and exterior mirrors, windscreens, rear windows, side windows, mudguards of bicycles and motorbikes, plastic visors of motorbikes, instruments of motorbikes, seats, saddles, door handles, steering wheels, tyre rims, fuel-tank ports (especially for diesel), number plates, luggage racks, roof containers for cars, and cockpits. For example, the coatings of the present invention used as an exterior coating of motor vehicles makes them easier to clean.

Operating equipment, devices and machines for commercial and industrial purposes and research, and parts thereof:

Moulds (e.g. casting moulds, especially those made of metal), hoppers, filling units, extruders, water wheels, rollers, conveyor belts, printing presses, screen printing stencils, dispensing machines, (machine) housings, injection-moulded components, drill bits, turbines, pipes (interior and exterior), pumps, saw blades, screens (for example for scales), keyboards, switches, knobs, ball bearings, shafts, screws, displays, solar cells, solar units, tools, tool handles, containers for liquids, insulators, capillary tubes, lenses, laboratory equipment (e.g. chromatography columns and hoods) and computers (especially casings and monitor screens).

Domestic articles and household equipment and parts thereof:

Furniture veneers, furniture strips, rubbish bins, toilet brushes, table cloths, crockery (for example made of porcelain and stoneware), glassware, cutlery (e.g. knives), trays, frying pans, saucepans, baking sheets, cooking utensils (e.g. cooking spoons, graters, garlic presses, etc.), inset cooking plates, hotplates, ovens (inside and outside), flower vases, covers for wall clocks, TV equipment (especially screens), stereo equipment, housings of (electrical) domestic equipment, picture glass, wallpaper, lamp and lights, upholstered furniture, articles of leather.

In particular the coating of furniture simplify cleaning and avoids visible surface marks.

Equipment, apparatus and accessories for games, sport and leisure:

Garden furniture, garden equipment, greenhouses (especially glazed), tools, playground equipment (e.g. slides), balls, airbeds, tennis rackets, table-tennis bats, table-tennis tables, skis, snow boards, surf boards, benches in parks, playgrounds, etc., motor bike clothing, motor bike helmets, ski suits, ski boots, ski goggles, crash helmets for suits and diving goggles.

Instruments, accessories and devices for medical purposes and sick persons:

Prostheses (especially for limbs), implants, catheters, anal prostheses, dental braces, false teeth, spectacles (lenses and frames), medical instruments (for operations and dental treatment), plaster casts, clinical thermometers and wheelchairs, and also, quite generally, hospital equipment, in order to improve (inter alia) hygiene.

In addition to the above articles it is also possible, of course, to coat other articles and parts thereof, advantageously, with the above coating compositions, examples of which being jewellery, coins, works of art (for example paintings), book covers, gravestones, urns, signs (for example traffic signs), neon signs, traffic light pillars, CDs, wet-weather clothing, textiles, post boxes, telephone booths, shelters for public transport, protective goggles, protective helmets, rockets, the inside of food packaging and oil canisters, films (for example for packaging foods), telephones, seals for water taps, and quite generally all articles produced from rubber, bottles, light-, heat- or pressure-sensitive recording materials (before or after recording, for example photos), and church windows, and also articles (for example made of steel plate) subject to graffiti (for example the exterior and interior of railway carriages, walls of underground and over ground urban railway stations, etc.).

It is possible to give photosensitivity to the liquid-repellent layer and it is possible to form optical gratings or other optical structures.

The following examples illustrate the present invention without restricting it.

### EXAMPLE 1

28 g of glycidoxypropyltriethoxysilane (0.1 moles), 18 g of methyltriethoxysilane (0.1 moles), 6.6 g of tridecafluoro-1,1,2,2-tetrahydroctyltriethoxysilane (0.013 moles, corresponding to 6 mole %, based on the total amount of hydrolyzable silanes), 17.3 g of water, and 37 g of ethanol were stirred at room temperature. Subsequently, the mixture was heated under reflux for 24 hours, which gave a condensation product. The condensation product was diluted with 2-butanol/ethanol to a solid content of 7% by weight.

To 100 g of the composite obtained, 0.04 g of an aromatic sulfonium hexafluoroantimonate salt (SP170® made by Asahi Denka Kogyo K.K.) were added as a cationic photoinitiator thereby obtaining a coating composition for a liquid-repellent layer.

### EXAMPLE 2

The same procedure of Example 1 for obtaining a condensation product was repeated, except that 6.6 g of tridecafluoro-1,1,2,2-tetrahydroctyltriethoxysilane were replaced by 4.4 g of a mixture of tridecafluoro-1,1,2,2-tetrahydroctyltriethoxysilane and 1H,1H,2H,2H-perfluorododecyltriethoxysilane.

Furthermore, the condensation product was diluted with 2-butanol/ethanol to a solid content of 7% by weight. To 100 g of this composite, 0.04 g of an aromatic sulfonium hexafluoroantimonate salt (SP170@ of Asahi Denka Kogyo K.K.) were added as a cationic photoinitiator thereby obtaining a coating composition for a liquid-repellent layer.

Curing and Evaluation

The coating compositions obtained in Examples 1 and 2 were each applied to a polyamide film by a roll coat method. The applied coatings were dried at a temperature of 90° C. for 1 minute.

Subsequently, the coatings were exposed to UV radiation and heated to 90° C. for 4 minutes. Then, curing was continued by heating to 200° C. for 1 hour in a heating oven to obtain the cured liquid-repellent layer of the present invention. Afterwards contact angles were measured to evaluate the level of liquid repellency to water. An automatic contact angle meter (Krüss G2) was used. Henceforth, Θₐ means an advancing contact angle and Θᵣ means a receding contact angle. The results are shown in table 1.

TABLE 1

| | Θₐ | Θᵣ |
|---|---|---|
| Example 1 | 110 | 90 |
| Example 2 | 118 | 97 |

Subsequently, the alkaline resistance of liquid-repellent layer was examined by immersing the polyamide film on which said liquid-repellent layer was formed in alkaline solution (NaOH aqueous solution pH=10-10.5) for four weeks at a temperature of 60° C. The results are shown in table 2.

TABLE 2

| | |
|---|---|
| initial | after immersion |

| | Θₐ | Θᵣ | Θₐ | Θᵣ |
|---|---|---|---|---|
| Example 1 | 110 | 90 | 93 | 76 |
| Example 2 | 118 | 97 | 109 | 89 |

After the immersion test, any peeling of liquid-repellent layer from said polyamide film was not observed. As can be seen from the results, the liquid-repellent layer of this invention showed a very high contact angle against water, i.e., a high liquid repellency. Further, sufficient liquid repellency was also maintained after said immersion test showing a long-term preservation even in alkaline solution. Moreover, an excellent adhesion on substrates was maintained after said immersion test assuming long-term preservation even in alkaline solution. Example 2 shows a further enhanced liquid repellency when the hydrolyzable condensation product comprises two or more hydrolyzable silane compounds having fluorinated alkyl groups of different length.

### EXAMPLE 3

### 2-Layer System

First, a bisphenol A diglycidylether type epoxy resin including SP170® as photoinitiator (2 wt % based on epoxy resin) was coated on a polyamide film by roll coating. Next, the coating composition obtained in Example 1 was coated on the above epoxy resin layer by direct coating. In this case, however, the coating composition of Example 1 did not contain a photoinitiator.

Subsequently, these 2 layers were exposed to UV radiation simultaneously and heated to 90° C. for 4 minutes. Then, curing was continued by heating to 200° C. for 1 hour in a heating oven to obtain the cured liquid-repellent layer of the present invention. Both layers were perfectly cured and showed the same high liquid repellency as that of the single layer of Example 1.

What is claimed is:

1. A coating composition for an alkali-resistant, liquid-repellent layer comprising:
a) a condensation product of at least one hydrolyzable silane having a fluorine-containing group and at least one hydrolyzable silane having a cationically polymerizable group, and
b) a cationic initiator.

2. The coating composition of claim 1 wherein the condensation product is prepared using at least one further silane, said at least one further silane comprising a further hydrolyzable silane selected from the group consisting of a silane having at least one alkyl substituent, a silane having at least one aryl substituent, and a silane having no non-hydrolyzable substituent.

3. The coating composition of claim 1 wherein said cationic initiator is a cationic photoinitiator.

4. The coating composition of claim 2 wherein said cationic initiator is a cationic photoinitiator.

5. The coating composition according to claim 1 wherein said at least one hydrolyzable silane having a fluorine-containing group is selected from compounds represented by the general formula (I)
RfSi(R)_{b}X_{(3-b)} (I)
wherein Rf is a non-hydrolyzable substituent having 1 to 30 fluorine atoms bonded to carbon atoms, R is a non-hydrolyzable substituent, X is a hydrolyzable substituent, and b is an integer from 0 to 2.

6. The coating composition according to claim 1 wherein said at least one hydrolyzable silane having a fluorine-containing group contains at least 5 fluorine atoms.

7. The coating composition according to claim 1 wherein the condensation product is prepared using at least two hydrolyzable silanes having a fluorine-containing group, which silanes have a different number of fluorine atoms contained therein.

8. The coating composition according to claim 2 wherein the condensation product is prepared using at least two hydrolyzable silanes having a fluorine-containing group, which silanes have a different number of fluorine atoms contained therein.

9. The coating composition according to claim 1 wherein said at least one hydrolyzable silane having a cationically polymerizable group is selected from compounds represented by the general formula (II)
RcSi(R)_{b}X_{(3-b)} (II)
wherein Rc is a non-hydrolyzable substituent having a cationically polymerizable group, R is a non-hydrolyzable substituent, X is a hydrolyzable substituent, and b is an integer from 0 to 2.

10. The coating composition according to claim 2 wherein said further hydrolyzable silane is selected from compounds represented by the general formula (III)
RₐSiX₍₄₋ₐ₎ (III)
wherein R is a non-hydrolyzable substituent selected from substituted or unsubstituted alkyl and substituted or unsubstituted aryl, X is a hydrolyzable substituent, and a is an integer from 0 to 3.

11. The coating composition according to claim 2 wherein said at least one hydrolyzable silane having a fluorine-containing group is selected from compounds represented by the general formula (IV)
CF₃(CF₂)ₙ-Z-SiX₃ (IV)
wherein X is as defined in general formula (I), Z is a divalent organic group, and n is an integer from 0 to 10, said at least one hydrolyzable silane having a cationically polymerizable group is a γ-glycidoxypropyltrialkoxysilane, and said further hydrolyzable silane is an alkyltrialkoxysilane.

12. The coating composition according to claim 1 wherein the amount of said at least one hydrolyzable silane having a fluorine-containing group is from 0.5% to 20% by mole, based on the total amount of hydrolyzable silanes.

13. The coating composition according to claim 2 wherein the amount of said at least one hydrolyzable silane having a fluorine-containing group is from 0.5% to 20% by mole, based on the total amount of hydrolyzable silanes.

14. The coating composition according to claim 2 wherein the proportion of said at least one hydrolyzable silane having the cationically polymerizable group and said further hydrolyzable silane is 10:1 to 1:10.

15. The coating composition according to claim 13 wherein the proportion of said at least one hydrolyzable silane having the cationically polymerizable group and said further hydrolyzable silane is 10:1 to 1:10.

16. A substrate having an alkali-resistant, liquid-repellent coating comprising a cured coating composition according to claim 1.

17. A substrate having an alkali-resistant, liquid-repellent coating comprising a cured coating composition according to claim 2.

18. A substrate according to claim 16 where the substrate is selected from metal, glass, ceramic or polymer substrates, said substrates being optionally pre-treated or pre-coated.

19. A process of preparing a substrate having an alkali-resistant, liquid-repellent coating, comprising:
a) applying a coating layer composition comprising a cationically photopolymerizable material and a cationic initiator to a substrate,
b) optionally drying said applied coating layer,
c) applying a coating composition for an alkali-resistant, liquid-repellent layer on said coating layer, the composition comprising a condensation product of at least one hydrolyzable silane having a fluorine-containing group and at least one hydrolyzable silane having a cationically polymerizable group, and
d) curing both layers.

20. The process of preparing a substrate according to claim 19 wherein both layers are cured simultaneously by irradiation.

21. The process of preparing a substrate according to claim 19 wherein the coating composition of step c) comprises a cationic initiator.

22. The process of preparing a substrate according to claim 19 wherein the cationically photopolymerizable material of the coating layer composition of step a) is a cationically photopolymerizable epoxy compound.

23. A substrate having an alkali-resistant, liquid-repellent coating obtained by a process according to claim 19.

24. A process of preparing a substrate having an alkali-resistant, liquid-repellent coating, comprising applying a coating composition as claimed in claim 1 on a substrate and curing the coating composition by irradiation, heating, or a combination thereof.
